(19) United States
(12) Patent Application Publication
(10) Pub. No.: US 2004/0035922 A1
(43) Pub. Date: Feb. 26, 2004

(54) System and method for time capture and billing

(76) Inventor: Michael Gallucci Cameron, McKinney, TX (US)

Correspondence Address: Michael G. Cameron, 2025 Savannah Drive, McKinney, TX, 75070, US

(21) Appl. No.: 10/638,667

(22) Filed: Aug. 11, 2003

Related U.S. Application Data
(60) Provisional application No. 60/404,667, filed on Aug. 20, 2002.
(60) Provisional application No. 60/405,181, filed on Aug. 22, 2002.
(60) Provisional application No. 60/418,630, filed on Oct. 15, 2002.

(51) Int. Cl. G06K 7/10

(52) U.S. Cl. 235/377

(57) ABSTRACT

The present invention comprises a time-based billing system and method using encoded billing cards, bar coded labels or billing docket sheets, among other possible methods, in combination with a sensor operable to decode the foregoing, as a means of generating data which includes, and correlates (i) the name of a unique data generator (including a person for whom data is generated, referred to as a “timekeeper”), a specific client number or identifier and project/matter number or identifier, with (ii) the exact date and time periods worked by said timekeeper, said data for export to a standard time and billing software program or system or used with an integrated time and billing software program.

### PRIORITY

This patent application claims priority to the following U.S. provisional patent applications: Serial No. 60/404,667 entitled “METHOD OF TIME-BASED BILLING USING ENCODED BILLING CARDS OR BILLING DOCKET SHEETS AND SYSTEM FOR IMPLEMENTATION THEREOF” filed Aug. 20, 2002; Serial No. 60/405,181 entitled “METHOD OF TIME BASED BILLING AND ACCOUNTING AND SYSTEM FOR IMPLEMENTATION THEREOF” filed Aug. 22, 2003 and Serial No. 60/418,630 entitled “APPARATUS AND METHOD FOR READING AND STORING ENCODED DATA FOR EXPORT TO SOFTWARE APPLICATIONS”, filed Oct. 15, 2002.

### BACKGROUND OF THE INVENTION

There are many types of timekeepers, such as lawyers, accountants, consultants and computer programmers. These timekeepers often bill their services to clients on an hour or partial hour (e.g., six minute) basis. In this manner, the only “inventory” possessed by a timekeeper is his/her time. In a service business that sells a timekeeper's time as its product, a primary method by which the timekeeper accounts for his or her time is with a handwritten paper time sheet. The most obvious example of this occurs at law firms. An attorney writes down the name or numeric identifier of the client, the project/matter number, and the approximate time, in sixths of an hour, etc., that he or she has worked on the matter. In an age when inventory of other businesses is kept electronically, the legal profession clings to an outdated mode of lawyers keeping track of their “time inventory” on paper. This information is then transcribed into a time and billing system. This mode of time capture is also used by other professionals such as accountants, consultants and computer programmers. The present invention automates the time capture and transcription aspect of the foregoing process.

In the blue collar world, employees are used to “punching a time-clock”. This is the primary means by which an employer can track the dates and times that the employee has worked. The unique employee identifier (as represented, for example, on a magnetic stripe or bar code on an employee badge) is correlated to date and time data when the badge is swiped in a time clock reader. This data is then input into a payroll system for generating an employee pay check. There is no similar analog of a “time-clock” for professional timekeepers who bill time to a specific client and then send out invoices. This is because there are fundamental differences in the manner that employees are tracked and paid and the manner in which the “time inventory” of professionals is tracked and paid. In fact, the primary method by which timekeepers keep time is to manually write down the time on billing time sheets. The information is then manually inputted by an administrative assistant or other data entry person into a time and billing software program or application. This process is time consuming and fraught with the potential for error. Often, “time inventory” is lost because a timekeeper may begin work before noting the time on the time sheet. Or “time inventory” may be over-billed because the timekeeper or his or her assistant improperly inputs the amount of time or bills it to the wrong client. One advantage of the present invention is that it requires the timekeeper to be diligent in billing his or her time. This is often preferred over trying to recreate billing timesheets. Using the encoded time capture and billing system of the present invention, a timekeeper can accurately generate and capture timekeeper, client, project/matter, date and time information. This data is then correlated and transformed, into a data file that can be exported directly into any one of the many time and billing software programs or systems that are available on the market. Alternatively, the invention can be made integral with a time and billing software system.

### SUMMARY OF THE INVENTION

The present invention comprises a system and method of capturing time and billing data for export to a time and billing software system. The present invention allows timekeepers and their clients to more clearly observe to what extent fee payments are actually paying for “time inventory” and allows timekeepers to more closely monitor and control the “sale” of this “time inventory”.

In one embodiment, a timekeeper would have a separate billing code, imprinted for example, on an adhesive label or card, for each client and each project/matter number. The billing card could be a credit card sized card with the code comprising a bar code imprinted on an adhesive label and affixed thereto, the bar code encoding the timekeeper name, client name and project/matter number. Alternatively, the adhesive bar coded label with the same encoded information could be attached to one or a plurality of working file folders. The billing card or label could be generated by the firm's accounting or client intake department after all firm formalities are completed (conflict checking, receipt of engagement letter and retainer, etc.) Each time a timekeeper (e.g., a lawyer) determines to work on a file, he or she would swipe or read the billing card or bar coded label with a device, such as a bar code scanner, bar code enabled PDA, bar code wand, etc., which is operable to read bar codes. A software or firmware application would automatically note and store the date and time of the first read or swipe and link it to the timekeeper, client and project/matter number information from the billing card. Any reads or swipes of other client and project/matter billing cards or same client/different matter billing cards could be “locked out” so long as the first card remained “active,” or other cards could be read or swiped so as to enable “double billing.” When the timekeeper finished working on that particular matter, for lunch or for the day, or for whatever reason, the same card would be swiped again, thus triggering the software or firmware application to note or store, in effect, the ending time of the work. The timekeeper could then be prompted to enter narrative task information, for example, by using encoded cards with task information or by entering text into a text box in the PDA. This data would be saved in the device, reader, scanner or PDA. This information would be either prompted or automatically downloaded via a wired or wireless connection to a time and billing system for calculation of hours and minutes worked for that particular client and matter, and generation of an invoice. The foregoing is just an illustration of one embodiment of the invention. Others are disclosed herein. As will be seen, the present invention automates the timekeeping function.

### FIGURES OF THE INVENTION

FIG. 1 illustrates an adhesive label with TkCM data encoded with bar codes thereon;

FIG. 2 illustrates a PDA device that is enabled to accept the swiping of an encoded billing card or billing docket sheet

FIG. 3 illustrates an optical wand that can be coupled to a Computing Device to capture TkCM data;

FIG. 4 is an illustration of an invoice indicating the information generated by the present invention;

FIG. 5 is an integrated bar code reader that permits date and time stamping; and

FIG. 6 is an integrated bar code reader in a form function similar to a writing pen.

### A DETAILED DESCRIPTION OF THE INVENTION

The present invention comprises a time-based billing system and method using encoded billing cards, bar coded labels or billing docket sheets, among other possible methods, in combination with a sensor operable to decode the foregoing, as a means of generating data which includes, and correlates (i) the name of a unique data generator (including a person for whom data is generated, referred to as a “timekeeper”), a specific client number or identifier and project/matter number or identifier, with (ii) the exact date and time periods worked by said timekeeper, said data for export to a standard time and billing software program or system or used with an integrated time and billing software program. The discussion herein, when referring to the bar code encoded billing card, shall be deemed to include the bar code encoded adhesive labels and billing docket sheets, unless the context clearly indicates otherwise. The method and system disclosed herein can be extended to generate data that correlates the occurrence of an action, such as making a copy, dialing a telephone call or sending a fax, to a specific client and matter, and to the exact date and time that the action occurred, also for export to a standard time and billing program or system. As will be seen herein, there are numerous advantages of this system and method over existing methods of capturing and documenting time.

There are many time and billing software programs that allow the timekeepers to start a clock on his or her computer in order to keep time with a mouse click. However, the disadvantages of such systems are similar to that disclosed with respect to paper time and billing methods. Time can be entered by anyone, it can be inadvertently entered and there is no way the client can control the amount of time spent by the timekeeper on a particular matter. By using the system and method disclosed herein, the client has more control over the number of timekeepers in a firm performing work for the client. The client can better ensure that time is not being double-billed. For timekeepers, the advantage of the system is that it makes it more difficult for clients to challenge invoices, as it creates a presumption of proper billing. It creates an incentive to work efficiently and on schedule, thus minimizing possible malpractice claims for the timekeeper. Within the firm, individuals who control a number of primary billing cards (as described herein) will enjoy a certain amount of prestige, thus encouraging others within the firm to develop clients so as to increase the number of such cards they hold. In this manner, the primary cards can become tangible evidence of a timekeeper's rainmaking ability. The use of the present invention is a benefit to both timekeepers and clients over the methods presently available to keep time.

The invention comprises, in but one embodiment, one or a plurality of media, including adhesive labels or billing cards, such as billing cards (each a “billing card”) dimensioned approximately the size of a credit card, such media being encoded with information, preferably a unique timekeeper identifier, client name identifier and project/matter information identifier. For example, a timekeeper, Michael G. Cameron, could be associated with a unique alpha, alpha-numeric or numeric identifier, such as MGC1, as encoded using a bar code, which would be consistent over all clients and matters on which Michael G. Cameron has authorization to bill time. The client, e.g., Acme Corporation would be associated with a unique identifier encoded on the billing card that would be consistent across all Acme Corporation project/matters, such as AC001. A separate identifier would be issued for each Acme project/matters, such as 00001 for “Widget Patent”, 00002 for “Smith Employment Lawsuit”, etc. Thus, if timekeeper Michael G. Cameron is authorized to bill time to the Acme Corporation Widget Patent project/matter, he would be issued adhesive labels or a billing card encoded with bar codes correlating to “MGC1-AC001-00001”.

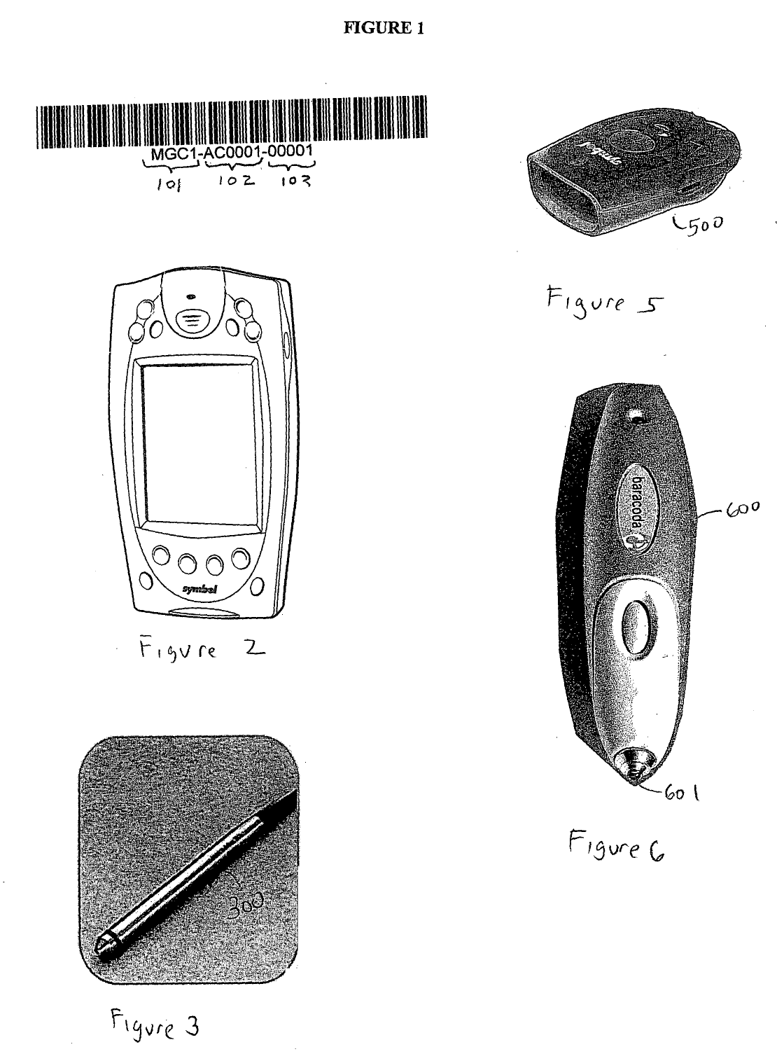

As seen in FIG. 1, the billing cards or adhesive labels that utilize the bar code embodiment of the invention can be easily created using standard bar code software and adhesive labels. As seen therein, the adhesive label 100 of FIG. 1 contains timekeeper or Tk data 101, client or C data 102 and matter/project or M data 103 (collectively, “TkCM data”). Once the bar code is printed on the adhesive label 100, the labels can be affixed to credit card sized plastic or laminated cards. Alternatively, the adhesive label 100 could be affixed to a working file. The encoded billing cards or encoded adhesive labels are then distributed to the appropriate timekeepers within the firm who are authorized to bill time to the client. In order to bill time to the client, the timekeeper must first swipe the appropriate billing card across the sensor to begin billing (as more fully described below). After the timekeeper has completed his or her work, he or she swipes the billing card again to terminate billing. At that time, the timekeeper could be prompted by the Computing Device to input information about the tasks performed, such information to be converted to Task data (“Ta data”), to be compiled with, and correlated to, the TkCMDT data.

The encoding can comprise a bar code, magnetic stripe or similar encoding media, representing the unique timekeeper, client and project/matter identifier. As used herein, bar code refers to the means for sensing a coded indicia formed by a combination of bars or bars and spaces having different light reflective characteristics. There are a number of symbologies that are used in bar code technology. Any appropriate symbology can be used to implement this invention. Preferably, the present invention is implemented using Code 39, Code 128 or PDF417. Preferably, a separate billing card would be generated for each client, with single or multiple matter identifier codes being included thereon. An alternative embodiment described below uses sheets of paper or similar media on which bar codes can be printed (referred to as a “billing docket sheet”).

The timekeeper causes the encoded media on the billing card, adhesive label or billing docket sheet to be read by a sensor, such as an bar code reader, optical reader, wand, scanner or magnetic reader. This can occur by swiping the billing card across the sensor or the sensor across the billing card or billing docket sheet or scanning or reading the encoded information. The sensor couples the modulated signals (be they optical, electrical or magnetic) to a conventionally available or dedicated device, personal digital assistant (“PDA”), dedicated handheld device, laptop or desktop computer or other similar computing device (any of the foregoing referred to as a “Computing Device”). FIG. 2 illustrates a typical PDA device 200 with an integral bar code reader that can be software configured to accomplish the objectives of the present invention. FIG. 3 illustrates an optical wand 300 that can be coupled to a Computing Device to capture TkCM data. Alternative integrated bar code readers and decoders can also be used to accomplish the objectives of the present invention.

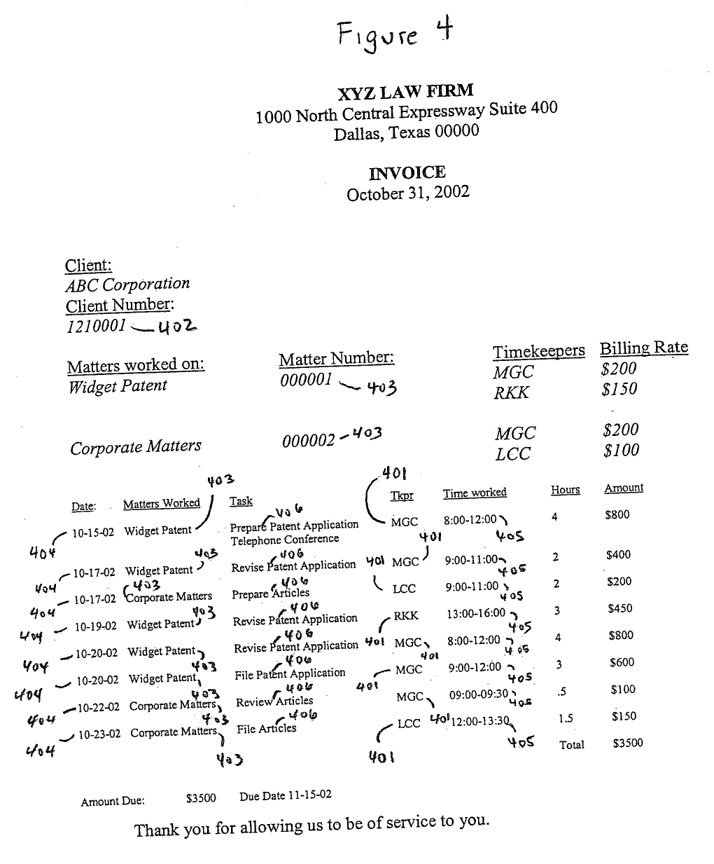

A digital circuit within the Computing Device correlates the TkCM data from the sensor with information about the date and time of the read or swipe (including time zone information, or GMT or Universal Coordinated Time information) as kept by a clock circuit within the Computing Device. The date and time information is referred to as the “DT data”. The timekeeper, client, project/matter, date and time data (“TkCMDT data”) thusly correlated in the Computing Device by associated Implementation Software (as defined below), and maintained in volatile or non-volatile memory in the Computing Device and any associated server can be supplemented with additional data supplied by the user, for example, via additional encoded media or a menu driven interface module that is part of the Implementation Software. For example, the additional data can include information about the tasks performed by the timekeeper (referred to as “Ta data” and with the TkCMDT data, referred to as “TkCMDTTa data”). If the TkCMDT data or TkCMDTTa data is recorded in a portable Computing Device, then it can be downloaded to a primary Computing Device, such as a workstation, mainframe or server which networks timekeepers across a firm and on which the firm's separate time and billing software application resides. The means of connecting the portable Computing Device to a primary Computing Device can be by a wired or wireless interface, such as a serial RS-232, universal serial bus (“USB”), infrared, wireless local area network (“WLAN”), bluetooth or any number of other wired or wireless schemes. For example, if the portable Computing Device is a PDA, the PDA can be placed in its docking station and hot-synced to the primary Computing Device on which the time and billing software resides. A module of the Implementation Software, residing on the Computing Device or on a separate server, configures the TkCMDT data or TkCMDTTa data for export into a software application such as a spreadsheet application, accounting application or a time and billing software program application. The downloaded TkCMDTTa data or TkCMDT data from all the timekeepers for a certain period of time is routed to the software application wherein additional information, such as hourly billing rates, is included and based thereon, a total due can be calculated, and an invoice generated, and sent or made available to the client as seen in FIG. 4 (as described below).

Firmware within a device or software is used to correlate the TkCM data and the DT data or DTTa data, and to configure the TkCMDT data or the TkCMDTTa data into a form that can be exported to the software application such as a spreadsheet, a conventional time and billing software program or accounting application. This can be accomplished within or coupled to Implementation Software. The Implementation Software is functionally a front end module into the software application said software application being a spreadsheet, a conventional time and billing software program or accounting application. The Implementation Software can further incorporate a standalone time and billing module. The Implementation Software can also have other modules or subroutines so as to permit value-billing or fixed-price arrangements on projects, as may be authorized by the client. The Implementation Software could include “locks” to prevent “double-billing”. The locks ensure that a timekeeper can not bill one client at the same time he or she is billing time to another client. Preferably, this “one time unit-one client” or “anti-double billing” feature could be overridden by those clients who have agreed to be double-billed by the timekeeper (of which, presumably, there will be few). The Implementation Software can cause the software application to include an automatic notice on an invoice to the affected clients that the timekeeper was permitted to double-bill. The Implementation Software can also cause other items to be flagged to the client on the invoice, such as hours billed over a certain threshold, etc. The Implementation Software can also include a web browser module so as to allow clients to review their bills in “real-time” over the Internet. Finally, the Implementation Software can include encryption features to ensure the confidentiality of the TkCMDT data and TkCMDTTa data.

The present invention does not claim the functions of a stand-alone software application such as a spreadsheet, a conventional time and billing software program or accounting application. Such software applications are presently available on the market. Nor does this invention claim core technology relating to encoding methods such as bar coding. The novelty and uniqueness of the present method and system is in the combined use of encoded media, such as bar coded adhesive labels, billing cards or billing docket sheets and ancillary Implementation Software on a Computing Device, as coupled to the software application, so as to permit a timekeeper to use machine-readable codes to capture and bill their time to clients on a project/matter basis.

The “swipe” of a sensor across an encoded media such as a bar coded billing card, adhesive label or a billing docket sheet acts as a trigger to commence billing to a particular client on a particular matter. The next swipe terminates billing to that client. Any intervening swipes of a different card (representing a different client and matter, or same client and different matter) can be made to be ineffective in the system. Once swiped, the TkCM data from the encoded billing card or billing docket sheet is correlated to DT data or DTTa data. This can occur in a reader or scanner or in a Computing Device using the Implementation Software. The data, as configured by the reader, scanner or Implementation Software, can then be exported to the conventional software application, such as a spreadsheet, a conventional time and billing software program or accounting program for the generation of client invoices. Additional embodiments of means for generating, correlating, saving and outputting TkCMDT data are disclosed, using a smart-card and/or a smart-wand.

The present invention can be adapted to utilize an encoded billing card, such as a bar code encoded card or card with a magnetic stripe, or billing docket sheets, to carry information used by a timekeeper, such as the client and matter number. The encoded billing card or billing docket sheets are prepared by the timekeeper or his or her firm's accounting or client intake department when the timekeeper is retained to perform services. The use of this method and system thus advantageously ensures that no time can be billed to an account until all intake procedures of the timekeeper's firm are completed. Such procedures could include completion of conflict checks and receipt of signed a engagement letter and retainer. The client, in consultation with the relationship timekeeper, would determine how many encoded billing cards are to be prepared for distribution to other timekeepers within the firm. This determination can be made at that time the client retains the timekeeper or his or her firm.

In an alternative embodiment, billing docket sheets or adhesive labels affixed to work folders can be used in lieu of, or with, billing cards. The billing docket sheets are sheets of paper that have imprinted thereon, the TkCM bar code information. Software packages are available which permit the generation of bar codes. A number of bar codes can thus be imprinted on a single sheet of paper. If the timekeeper's firm desires, such billing docket sheets can be delivered daily to all firm timekeepers as a document attachment to e-mail. Alternatively, bar codes can be imprinted on adhesive labels, such as Avery labels, that can be affixed to work file folders.

There are preferably two classes of encoded billing cards used in the present invention. The first class is the primary billing card. It is preferably can be a different color to distinguish it from the subordinate billing card(s). For example, in a law firm, the relationship partner would hold the primary billing card and associates who are authorized to bill time to a matter would be given subordinate billing cards. For example, but not limitation, the primary billing card could red and the subordinate billing cards could be white. The Implementation Software could be configured to permit the holder of the red card to authorize others to bill time to the client and matter by swiping the billing card and entering time on behalf of the otherwise unauthorized timekeeper. Limits can be placed on this activity, for example, by encoding the billing card with data that causes Implementation Software to limit the amount of time that an otherwise unauthorized person can bill. Additional classes of cards with coding that invokes special rights or limitations could also be created. The Implementation Software would have modules or subroutines that would check any number of parameters placed on the use of each billing card, as dictated by the client.

As noted above, if the embodiment of the present invention comprises the use of billing docket sheets, the Implementation Software can include an e-mail module whereby each day (or other designated period), every timekeeper of the firm is e-mailed, or otherwise delivered or made available, a document that can be printed on a laser or similar printer, such document containing the bar codes for the clients and matters on which the designated timekeeper is authorized to bill time on that day (or during that period). In such embodiment, the bar code itself can include information about the date on which the bar coded billing docket sheets were sent to the timekeeper. In such manner, additional restraints can be placed by the client on the billing activities of the timekeepers.

The TkCM data from the bar code, coupled with the DT data or DTTa data generated in the Computing Device, would be configured for export to a conventional time and billing software program to create an invoice. The TkCMDT data and/or TkCMDTTa data can also be stored in a database on a permanent or semi-permanent storage medium for further reference.

FIG. 4 illustrates a typical invoice that would be outputted from a time billing system using data generated using the time capture system and methodology of the present invention. As seen on the invoice, timekeeper or Tk data 401; client or C data 402; matter/project or M data 403; date or D data 404; time worked or T data 405 and optional task or Ta data 406. Based on the foregoing, the billing software program would generate invoice 400 and calculate hours worked and amount to be billed.

The billing cards would be read using optical or magnetic readers or similar sensors, depending on the encoding scheme used on the billing card. The TkCM data read therefrom by the sensor would be coupled with DT data provided by a clock source or circuit within the Computing Device. The DT data can be localized, such as the US Central Time Zone, or based on a universal standard, such as Coordinated Universal Time. Once the billing card is “swiped” or otherwise read by the appropriate sensor, the Computing Device initializes and reads the TkCM data into memory, and the exact date and time (DT data) when the card was swiped, i.e., when work for the client commenced. So long as one billing card of a particular timekeeper is “active”, no other cards issued to that timekeeper can be initialized into the system. This “lock-out” feature prevents double billing (by client or matter) by a single timekeeper. It is only when the “active” card is swiped again, does the time being logged terminate, allowing a different client or matter to be billed by such timekeeper. If a plurality of Computing Devices are used by a single timekeeper to log time, such as a desktop computer and a PDA, the Implementation Software preferably requires the PDA to be docked with the computer before the computer will accept the TkCM data from a sensor coupled to the computer. In this manner, the PDA can be checked to ensure that time is not then being billed to another client or on a different matter. In any event, the Implementation Software module that compiles all the TkCM data will not permit any particular time unit to be billed to two clients by a unique timekeeper, unless specifically overridden as described above.

The symbology used to create the TkCM data can utilize any one or variety of coding schemes. For example, Code 39 is one of the most popular general-purpose bar codes in use today. The basic symbology accommodates both letters and numbers, plus eight other frequently used characters. In addition to the basic symbology, it is possible to obtain plug-in modules that support extended Full ASCII bar codes, FACT Data Identifier prefixes, optional Mod 43 check digits digits, and automatic generation of WebCodes (instant publishing of bar codes for web-hosted FileMaker Pro databases). Code 39 is extremely reliable, easy to scan, and highly tolerant of minor printing imperfections. Because of these factors, it has become an official standard in many sectors of industry, business, government, and academia. Code 128 is a versatile, high-density, variable-length bar code symbology that accommodates letters, numbers, and a variety of other ASCII characters. By using three different character sets (A, B and C) and shift codes to switch between sets, Code 128 is able to deliver full-ASCII bar codes to meet a variety of specialized needs. Code 93 is a high-density, general-purpose full-ASCII bar code with secure double Mod 47 error checking. It is a more efficient code than Code 128 when processing random alphanumeric character strings. Code 128 is extremely reliable.

The Implementation Software can include preset limits at which time the billing card must be re-swiped in order to continue to bill time. Alternatively, the Implementation Software can require specific client authorization before additional time is billed to a certain matter or account. For example, the client may only authorize the timekeeper to bill a total of 10 hours on a research project. Once the associate (in the law firm environment) working on the research project reaches 10 hours, billing is automatically stopped for that billing card unless further authorization is received from the client. An audible chime or other reminder can be set by the Implementation Software in the Computing Device to alert the timekeeper prior to or at the end of the billing period. Only information entered into the time and billing software system via the Implementation Software may be billed to the client. The Implementation Software will be “locked” such that time cannot be entered into the system manually unless specific override features are triggered. Preferably, only the client will have a “key” that can unlock the Implementation Software, thus allowing the timekeeper (e.g., the holder of the red card) to enter time manually. The Implementation Software, as used with a conventional time and billing software program, can be Internet enabled allowing the client to review the status of time entered by timekeepers at any time.

As noted above, in addition to storing and outputting DT data with TkCM data, the timekeeper would have the opportunity to input, via an input device such as a keyboard, scratchpad, mouse, etc., descriptive information about the services being performed during the billed unit of time, i.e. Task data. For example, a lawyer may swipe a billing card to either commence or terminate billing activity, then be prompted to input information in a text box on a PDA screen. Such information can be pre-programmed, such as “Review contract,” or “Prepare patent application”, thus permitting the timekeeper to merely click in the information. In other words, the Implementation Software associated with the present invention, can have pre-determined tasks that can be chosen via a menu-driven interface.

An advantage of the present system is that at any particular time, a timekeeper can only bill time to one client. This feature prevents double-billing. The moderate amount of discipline and effort required to use the method and system is more than offset by the benefits to the clients. The TkCM data represented by the encoded billing card or billing docket sheets, coupled with the DT data, as correlated and configured by the Implementation Software, enables more accurate timekeeping and billing. The encoded TkCMDT data or TkCMDTTa data can also be coupled to word processing programs and document management systems for inclusion thereon so that additional information about the provision of services can be included in the invoice to the client. The TkCM data encoded cards can also be used to activate the use of fax machines, telephones for long distance calls, copier machines, etc., so long as these devices are appropriately coupled to sensors, such as optical readers, wands, IR readers, scanners or magnetic readers, that can read the encoded billing cards or billing docket sheets. In such case, the invoice to the client would have not only the information about the tasks performed by the timekeeper, but also the exact dates and times during which the timekeeper was performing certain activities for the client. The exact time a fax was sent, a call was made, or a copy was made, could be easily included on the invoice to the client.

The Implementation Software would be interfaced with time and billing software. The time and billing software would be configured to accept the TkCMDT data or TkCMDTTa data from the Implementation Software, correlate additional information such as the hourly billing rate of each timekeeper who has billed time, obtain a total invoice amount based on hours billed times hourly rates, save said invoice in a memory location and output an invoice which can be printed or sent to the client electronically.

An alternative embodiment of the present invention is the use of a “smart-card” as the generator of TkCMDT data for export to the Implementation Software or directly to the time and billing software program. The smart card would be a credit card sized card, with internal circuitry to generate the date and time (the internal clock being operable to keep local time, GMT or Universal Coordinated Time), and correlate TkCM data to DT data and have sufficient memory capacity to hold TkCM data. In contrast to a multipurpose PDA, a smart-card would only be used only to generate and store TkCM data. The smart card would have a means of outputting the TkCMDT data or TkCMDTTa data, for example, via a port, to a networked computer or other Computing Device on which the Implementation Software and time and billing software is linked. The Implementation Software, in conjunction with the hardware, can be used to download new or additional data into the smart-card. The smart-card would have a unique digital identifier that is correlated to a specific timekeeper. Each day, or other regular or semi-regular basis, the timekeeper would dock the smart-card to the computer system on which the Implementation Software is running to obtain new CM data and to download TkCMDT data. The smart-card would have a means of allowing the timekeeper to select the client and matter to be billed, as well as a means of commencing and terminating the time-keeping operation.

Another embodiment of the present invention is the use of a “smart-wand” as the generator of data for export to the Implementation Software or directly to the time and billing software program. FIG. 5 is an integrated bar code reader that permits date and time stamping FIG. 6 is an integrated bar code reader in a form function similar to a writing pen.

The smart reader 500 of FIG. 5 has contained therein microprocessor circuitry necessary to generate DT data and to correlate the DT data to the TkCM data. Furthermore, the smart reader 500 has memory circuitry operable to save the TkCMDT data until such time that the TkCMDT data is downloaded into a computer or server on which the Implementation Software and time and billing software resides. The smart wand/reader has a means of outputting the TkCMDT data or TkCMDTTa data, for example, via a port or other wired or wireless connection, to a networked computer or other Computing Device on which the Implementation Software and time and billing software is linked. The Implementation Software, in conjunction with the hardware, is used to download new or additional firmware into the smart wand. The smart wand has a unique digital identifier that is correlated to a specific timekeeper. Each day, or other regular or semi-regular basis, the timekeeper docks the smart-wand to the computer system on which the Implementation Software is running to (i) obtain new firmware and to (ii) download TkCMDT data. As seen in FIG. 6, the smart wand 600 is dimensioned similar to an expensive fountain pen. An optical sensor is located at the tip 601 thereof is operable to read bar codes off an encoded billing card or billing docket sheet. The TkCM data would be read by and into the smart wand when the timekeeper swipes the smart wand across the billing card or billing docket sheet.

The use of a discreet smart wand with bar code encoded billing cards may be preferred by a professional, such as a lawyer, who does not want to be perceived as “punching a time clock”. The smart wand would likewise have a docking station by which the TkCMDT data is downloaded into the computer or server. The smart wand could also have incorporated therein a “smart-pen” feature. The “smart-pen” feature is similar to the “graffiti” writing feature of conventional PDAs, however, the interpreted alphanumeric data is determined, not by a touch pad, but rather by a sensing mechanism within the pen that calculates the orientation of the pen and the acceleration and movement of the pen by the timekeeper. The use of the smart pen feature, as incorporated into the smart wand, or separate thereto, can be the means of incorporating Task data with the TkCMDT data.

Any of the smart card, smart wand or smart pen can be powered by an internal rechargeable battery, such as a NiCad or L-Ion battery. The power source can thus be recharged when the device is docked, assuming the docking station has a dedicated power pin, as does the USB interface. Further, any of the circuitry operable to generate DT data is operable to be coupled to a receiver to receive time signals from an external time source, such as the WWV time clock, as operated by the US Bureau of Standards, or GPS satellites.

The innovative teachings of the present invention are described with particular reference to the bar code encoded billing cards, docket billing sheets, magnetic stripe billing cards, smart-cards, smart wands or other input device, for use in conjunction with the Implementation Software for generation and storage of specific data for export to a time and billing software program and application. However, it should be understood and appreciated by those skilled in the art that these embodiments provide only a few examples of the many advantageous uses and innovative teachings herein. Various alterations, modifications and substitutions can be made to the disclosed invention without departing in any way from the spirit and scope of the invention.

I claim:

1. A time capture system, comprising:
an encoded media containing encoded timekeeper, client and matter data;
a sensing means for reading said encoded timekeeper, client and matter data;
a computing means for correlating date and time data to said encoded timekeeper, client and matter data.

2. A time capture system, comprising:
a computer;
a computer operating system for controlling said computer;
a software application for further controlling said computer;
said software application having database capabilities to accept and store information corresponding to one or a plurality of timekeepers, including one or more timekeeper billing rates and a unique timekeeper code identifying each unique timekeeper, information relating to one or a plurality of clients, including a unique client code identifying each unique client; and information relating to one or a plurality of project/matters, including a unique project/matter code identifying each unique project/matter of a particular client;
a machine-readable code generator operable to generate a machine-readable code representing the timekeeper code which correlates to a unique timekeeper;
said machine-readable code generator operable to generate a machine-readable code representing the client code which correlates to a unique client;
said machine-readable code generator operable to generate a machine-readable code representing the project/matter code which correlates to a unique project/matter;
a means of outputting said generated machine-readable timekeeper code, machine-readable client code and machine-readable project/matter code onto a machine-readable media;
a machine-readable code reader device for sensing generated machine-readable timekeeper, client and project/matter codes from said machine-readable media transforming the machine-readable timekeeper, client and project/matter codes into timekeeper data, client data and project/matter data;
a clock device for generating date data and time data;
said clock device being coupled to the machine-readable code reader device;
said coupled clock device and machine-readable code reader device being operable to correlate the timekeeper data, client data and project/matter data to date data and time data correlating to the date and time sensed by the machine-readable code reader device;
the machine-readable code reader device and clock device, together or singly, being adapted to export the timekeeper data, client data and project/matter data and correlating date data and time data into an input port of the computer under the control of said computer operating system and said software application;
said software application, optionally, containing an algorithm for accepting or rejecting the timekeeper data, client data and project/matter data based on rules contained in said software application;
said software application further having an algorithm for determining the nature and type of sensed and accepted timekeeper data, client data and project/matter data through a sorting process;
said software application having an algorithm for matching pairs of identical timekeeper data, client data and project/matter data, beginning with the first sensed entry based on the date data and time data;
said software application having an algorithm for operating on date data and time data corresponding to said paired sets of timekeeper data, client data and project/matter data so as to determine an elapsed time between each paired sets of data, representing time spent by a unique timekeeper on a unique client and unique project/matter; and
said software application having an algorithm for using the elapsed time and the unique timekeeper's periodic rate, as stored by the database, to calculate the value of time to be billed to the client.

3. The time capture system of claim 2, further comprising:
said software application being adapted to flag to the user that a set of sensed timekeeper data, client data, and project/matter data with correlating date data and time data is unpaired, and hence “active”, so long as there has not been sensed another set of identical timekeeper data, client data, and project/matter data with correlating date data and time data.

4. The time capture system of claim 3 further comprising a module operable to generate, format and output an invoice reflecting the value of time to be billed to a client.

5. The time capture system of claim 2, further comprising: said machine-readable code generator being integral to the software application.

6. The time capture system of claim 2, further comprising:
said clock device being integral to the machine-readable code reader device;
said integral clock device and machine-readable code reader device having an internal means for correlating and storing said captured timekeeper data, client data and project/matter data to corresponding generated date data and time data;
said integral clock device and machine-readable code reader device being adapted to export the stored and correlated timekeeper data, client data, project/matter data, date data and time data to the computer.

7. The time capture system of claim 6, further comprising the integral clock device and machine-readable code reader device being adapted to flag the user that a set of sensed timekeeper data, client data and project/matter data with correlating date and time data is unpaired, and hence “active”, so long as there has not been sensed a set of identical timekeeper data, client data and project/matter data with its correlating date and time data.

8. The time capture system of claim 6, further comprising the integral clock device and machine-readable code reader device having a means of storing and displaying an active timekeeper code, client code and/or project/matter code.

9. The time capture system of claim 8, further comprising said means of displaying an active timekeeper code, client code and/or project/matter code by the integral clock device and machine-readable code reader device being an LCD screen.

10. The time capture system of claim 6, further comprising the integral clock device and machine-readable code reader device having an internal, user selected module for restricting the sensing of a particular timekeeper code, client code or project/matter code.

11. The time capture system of claim 10, wherein said internal, user selected module for restricting the sensing of a different timekeeper code, client code or project/matter code is based on whether another timekeeper code, client code or project/matter code is active.

12. The time capture system of claim 10, wherein said internal, user selected module for restricting the sensing of a different timekeeper code, client code or project/matter code is based on the date data an/or time data provided by the clock device.

13. The time capture system of claim 12, wherein the machine-readable code generator and machine-readable code reader device comprises a bar code generator and a bar code reader.

14. The time capture system of claim 13, wherein said bar code reader comprises a bar code scanner.

15. The time capture system of claim 13 wherein said bar code reader comprises a bar code wand.

16. The time capture system of claim 2, wherein said machine-readable code generator and machine-readable code reader device further comprises a bar code generator and a bar code reader.

17. The time capture system of claim 16 wherein said bar code reader further comprises a bar code scanner.

18. The time capture system of claim 16 wherein said bar code reader further comprises a bar code wand.

19. The time capture system of claim 2 further comprising a machine-readable code generator for generating and outputting a task code representing task data that correlates to a unique task; and
said task code being correlated to a timekeeper code, client code, and project/matter code based on the date data and time data of the sensed task code.

20. The time capture system of claim 2 further comprising a means of coupling a facsimile machine to a machine-readable code reader device so as to correlate facsimile machine use to a specific timekeeper code, client code and/or project/matter code.

21. The time capture system of claim 2 further comprising a means of coupling a telephone to a machine-readable code reader device so as to correlate telephone use to a specific timekeeper code, client code and/or project/matter code.

22. The time capture system of claim 2 further comprising a means of coupling a copier to a machine-readable code reader device so as to correlate copier use to a specific timekeeper code, client code and/or project/matter code.

23. The time capture system of claim 2 wherein said software application further comprises a time and billing software engine.

24. The time capture system of claims 2 wherein said software application further comprises a spreadsheet software engine.

25. The time capture system of claim 2 where in said software application further comprises an accounting software engine.

26. The time capture system of claim 2 wherein said machine-readable generated timekeeper code, client code and project code comprises magnetic information.

27. A bar code reader and storage device, for sensing and storing bar code data, comprising:
an internal clock circuit for generating time and date data;
a bar code sensor for reading bar code data into a first temporary memory location;
a module for date and time stamping the bar code data as it is sensed and stored in a first, temporary memory location;
a second memory unit for available for storing a plurality of sensed bar codes and date and time data;
a memory location within said second memory unit set aside as the “active” location;
a means of clearing all second memory unit locations;
an internal logic circuit which requires, for storage of a particular string of bar code data in the second memory unit, that all existing bar code data in the second memory location be correlated as pairs of identical strings (excluding the date and time data) of bar code data or that such particular string of bar code data identically match that string of bar code data (excluding the date and time data) in the “active” memory location, or that there be no string of bar code data in the “active” memory location;
an internal logic circuit that determines if the string of sensed bar code data identically matches the string of bar code data (excluding the date and time data) in the “active” memory location, then the identically matching bar code data, are paired, correlated and moved to a new location in the second memory unit, thus opening up the “active” memory location;
a display means of displaying the bar code data located in the “active” memory location; and
a means of outputting said plurality of paired sets of bar code data and their corresponding date and time data to a computing device.

28. The bar code reader and storage device of claim 27, wherein said bar code data represents timekeeper codes, client codes and project/matter codes.

29. The bar code reader and storage device of claim 28, further comprising a software application for controlling a computing device that receives said outputted bar code data, said software application being operable to generate an invoice based on the plurality of paired sets of bar code data with corresponding date and time data.

30. A method of capturing and correlating timekeeper, client, project/matter, date and time information for use in generating an invoice, comprising:
storing a plurality of information about one or more unique timekeepers, one or more unique clients and one or more unique project/matters in a database;
storing in said database, timekeeper information including one or more periodic billing rates;
generating a timekeeper code which identifies a unique timekeeper;
generating a client code which identifies a unique client;
generating a project/matter code which identifies a unique project/matter;
outputting said generated timekeeper code, client code and project/matter code to a media so as to be sensed by a reader;
generating date data and time data;
sensing a plurality of sets of timekeeper codes, client codes and project/matter codes;
immediately after sensing each set of timekeeper codes, client codes and project/matter codes, correlating said sets of sensed timekeeper codes, client codes and project/matter codes to the then current date data and time data;
storing said sets of correlated timekeeper codes, client codes, project/matter codes, date data and time data as a group of data;
matching said groups of data in pairs, starting with the first sensed group, based on identical timekeeper codes, client codes and project/matter codes
determining the time elapsed between said paired groups of data by reference to the date data and time data.
calculating the value of the time worked on a unique client and project/matter by a particular timekeeper by multiplying the time elapsed by the timekeeper's periodic billing rate.

31. The method of claim 30, further comprising generating the timekeeper codes, client codes and project/matter codes using bar coding techniques.
